(19) United States
(12) Patent Application Publication
(10) Pub. No.: US 2008/0110444 A1
(43) Pub. Date: May 15, 2008

(54) IMPULSE GENERATOR FOR CAR IGNITION SYSTEM

(76) Inventor: Linming LIU, Taipei City (TW)

Correspondence Address: LEONG C LEI, PMB # 1008, 1867 YGNACIO VALLEY ROAD, WALNUT CREEK, CA, 94598, US

(21) Appl. No.: 11/559,900

(22) Filed: Nov. 15, 2006

(51) Int. Cl. F02P 3/01; F02P 3/02

(52) U.S. Cl. 123/606

(57) ABSTRACT

The device is an impulse generator which produces very high-frequency pulses. The device is installed along the primary circuit of the ignition system. The high-frequency pulses running through the primary circuit will induce similarly high-frequency pulses on the secondary circuit via the ignition coil. The induced high-frequency pulses then run though the spark plugs via the secondary circuit. These pulses will not add to additional burden to the ignition system but can effectively prevent the build-up of electrically resistive materials, especially the deposits on the spark plugs.

### BACKGROUND OF THE INVENTION

(a) Technical Field of the Invention

The present invention generally relates to the car ignition system, and more particularly to an impulse generator for preventing the build-up of electrically resistive materials along the circuits of the car ignition system.

(b) Description of the Prior Art

The ignition system of a car has to work in perfect concert with the car's engine. The goal is to ignite the fuel/air mixture in the engine's cylinders by sparks at exactly the right time so that the expanding gases can do the maximum amount of work. If the ignition system fires (i.e., provides the sparks) at the wrong time, power will fall and gas consumption and emissions can increase.

As shown in FIG. 1, a conventional ignition system mainly contains four components; a battery 101, an ignition coil 103, a distributor 108, and a number of spark plugs 203.

Each spark plug 203 is positioned on a cylinder of the engine and generates sparks as electricity is forced by a very high voltage to arc (or jump) across a gap between its electrodes. As can be imagines, the larger the gap is, the higher the voltage is required. Usually, the gap is between 0.02-0.04 inches and the voltage should be at least 14,000 volts.

The ignition coil 103 is the device that produces the high voltage required to create a spark from the low, DC voltage (e.g., 6-12 volts) provided by the battery 101. The ignition coil 103 is essentially a transformer having a primary winding 105 and a secondary winding 106. The secondary winding 106 normally has hundreds of times more turns of wire than the primary winding 105. When a driver turns the key inserted in the ignition of the car, the ignition switch 102 is closed and current flows from the battery 101 through the low-voltage cable 107 and the primary winding 105 to the breaker points 109 inside the body of the distributor 108. If the breaker points 109 form a closed circuit, the current will flow back to the battery 101, causing an electromagnetic field being developed by the primary winding 105 and an iron core 104 of the ignition coil 103.

When the electromagnetic field is suddenly disrupted by breaking up the closed circuit of the breaker points 109, the rapidly changing electromagnetic field induces a very high voltage in the secondary winding 106, which is delivered to the cap of the distributor 108 via a very well insulated, high-voltage cable 202.

A distributor cam 201 spin in the center of the body of the distributor 108 to push a lever connected to one of the breaker points 109. Whenever the cam 201 pushes the lever, it opens the breaker points 109 to disrupt the electromagnetic field produced by the primary winding 105.

A rotor 110 in the cap of the distributor 108 connected to the high-voltage cable 202 distributes the high voltage from the secondary winding 106 to the spark plugs 203. The rotor 110 spins past a series of contacts, one contact per spark plug 203. As the tip of the rotor 110 passes each contact, the high voltage from the secondary winding 106 continues down to the spark plug 203 on the appropriate cylinder.

Based on the foregoing description, the ignition system can be divided into a primary circuit and a secondary circuit. The primary circuit is the low-voltage section which contains the battery 101, the ignition switch 102, the body of the distributor (including the breaker points 109 and the cam 201), and the primary winding 105. The secondary circuit is the high-voltage section which contains the secondary winding 106, the cap of the distributor 108 (including the rotor 110), and the spark plugs 203.

As mentioned earlier, the right timing of the sparks has significant impact on the performance of the engine, the gas consumption, and the exhaust emissions. One critical factor that affects the spark timing is the build-up of electrically resistive materials along the primary circuit and the secondary circuit of the ignition system. A typical example of the electrically resistive materials is the deposits from the fuel additives built up on the plugs, especially on the tip of the center electrode of the plugs.

### SUMMARY OF THE INVENTION

The primary purpose of the present invention is to provide a device to help preventing the build-up of the electrically resistive materials along the primary and secondary circuits of the ignition system.

The device is an impulse generator which produces very high-frequency pulses. The device is installed across the primary circuit of the ignition system. The high-frequency pulses running through the primary circuit will induce similarly high-frequency pulses on the secondary circuit via the ignition coil. The induced high-frequency pulses then run through the spark plugs via the secondary circuit. These pulses will not add to additional burden to the ignition system but can effectively prevent the build-up of electrically resistive materials, expecially the deposits on the spark plugs.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a conventional car ignition system.

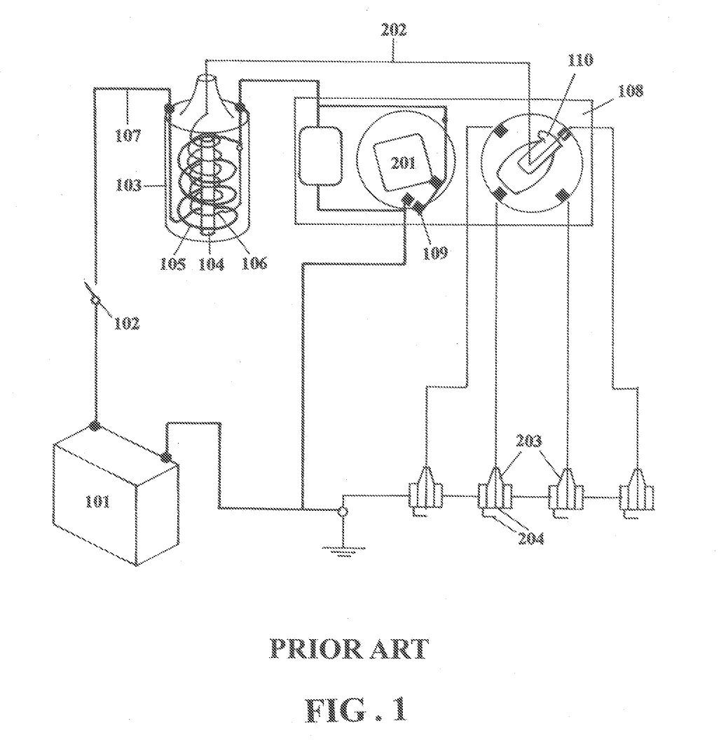

FIG. 2 is a schematic diagram showing a device according to an embodiment of the present invention.

FIG. 3 is a schematic diagram showing the relationship between the device of FIG. 2 and the ignition system.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

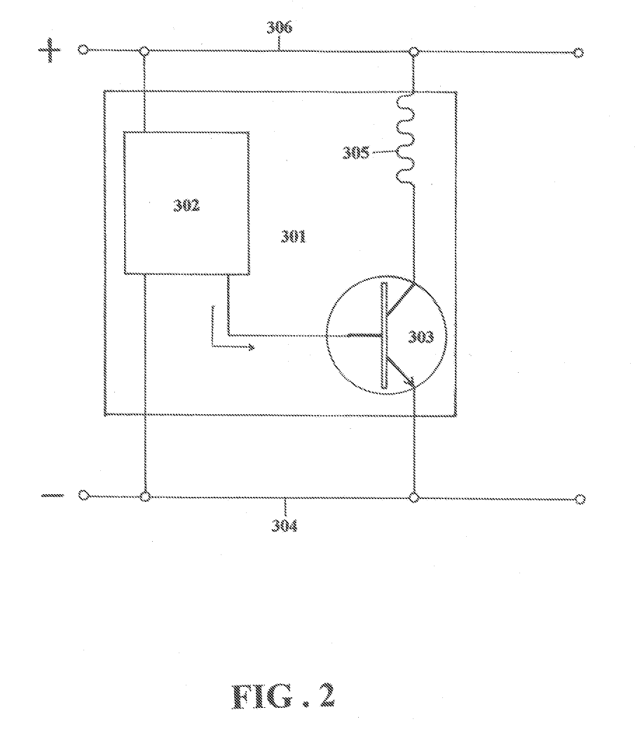

As shown in FIG. 2, a device 301 according to an embodiment of the present invention is essentially an impulse generator. The device 301 is parallel-connected to the primary circuit of the ignition system between the positive (+) terminal 306 and negative terminal (−) 304 of the battery. The device 301 contains an oscillator 302, a transistor 303, and an inductor 305. The oscillator 302 is operated under an appropriate oscillation frequency. The output of the oscillator 302 is connected to the base of the transistor 303 and therefore a pulse train of an appropriate frequency produced by the oscillator 302 drives the transistor 303. The emitter of the transistor 303 is connected to the negative terminal 304 of the battery. On the other hand, the collector of the transistor 303 is series-connected to a terminal of the inductor 305, which in turn has the other terminal connected to the positive terminal 306 of the battery. As such, the device 301 is able to produce a series of high-frequency pulses along the primary circuit of the ignition system. The high-frequency pulses are usually at a frequency between 500-700 KHz, which will not place additional burden on the ignition system.

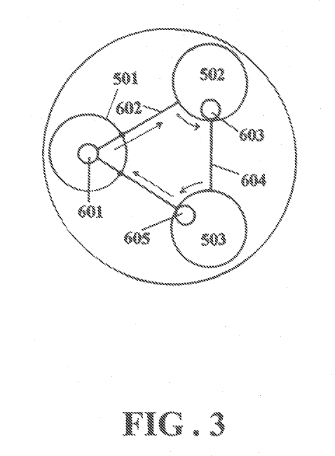

FIG. 3 is a schematic diagram showing the relationship between a device 601 of the present invention and the ignition system. As illustrated, the device 601, parallel-connected to the battery 501, produces high-frequency pulses to the ignition coil 603 of the primary circuit 502 via the low-voltage path 602. Similarly high-frequency pulses will be induced on the secondary circuit 503 and runs along a high-voltage path 604 to the center electrodes of the spark plugs 605. As such, the high-frequency pulses will effectively prevent the build-up of electrically resistive materials along the circuits, expecially on the tip of the center electrode of the spark plugs.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A device parallel-connected between the positive and negative terminals of the battery of the ignition system of a car, said device comprising:
a transistor whose emitter is connected to the negative terminal of the battery;
an inductor having one terminal connected to the collector of said transistor and the other terminal connected to the positive terminal of the battery; and
an oscillator whose output is connected to the base of said transistor;
wherein said device produces high-frequency pulses running through the primary circuit of the ignition system; said high-frequency pulses induce similarly high-frequency pulses on the secondary circuit via the ignition coil of the ignition system; and the induced high-frequency pulses run through the spark plugs via the secondary circuit for preventing the build-up of electrically resistive materials.
